(19) United States
(12) Patent Application Publication
(10) Pub. No.: US 2008/0093555 A1
(43) Pub. Date: Apr. 24, 2008

(54) METHOD TO DETERMINE WATER CONTENT IN A SAMPLE

(75) Inventors: Michel J.L.M. Peeters, Horst (NL); Allard F.H. Peperkamp, Wijchen (NL)

Correspondence Address: ORGANON USA, INC.;PATENT DEPARTMENT, 56 LIVINGSTON AVENUE, ROSELAND, NJ, 07068, US

(73) Assignee: N.V. Organon, Oss (NL)

(21) Appl. No.: 11/864,023

(22) Filed: Sep. 28, 2007

Related U.S. Application Data
(60) Provisional application No. 60/848,552, filed on Sep. 29, 2006.

(51) Int. Cl. G01J 5/02

(52) U.S. Cl. 250/343

(57) ABSTRACT

This invention provides a method to determine the content of water in a sample by liberating the water from the sample followed by capturing the liberated water in a gas flow and measuring cumulatively the water vapour content in the gas flow by spectroscopy, preferably frequency modulated spectroscopy.

This invention relates to a method to determine the content of water in a sample by capturing the water in a gas flow and measuring cumulatively the water content in the gas flow.

It is a standardized method to measure water content in a sample according to the Karl Fischer method. In practice this method is to liberate the water in the sample to the gas phase by heating the sample and capturing the water vapour in a gas flow. The gas flow is led to a reaction vessel wherein the water content is measured by titration with the Karl Fischer reagent solution. The latter solution is a water free organic solvent containing iodine and an alkylsulfite, which is buffered for maintenance of slightly acidic or neutral pH. The iodine is reduced quantitatively by the alkylsulfite towards iodide and alkylsulfate, whereby water is an essential component in the reaction. The reaction proceeds in stoichiometric proportion to H₂O, when introduced into the solution. The progress of the reaction is monitored by electric probes responding to iodine or, alternatively, the amount of iodide formed is measured coulometrically. The method is known since 1935 and many improvements have been made over the ensuing decades, for example WO 00/72003 and WO01/36968. The reaction is not always completely insensitive to other compounds in the sample. Accuracy and detection limits were improved over the following decades by proper choice of organic solvent, the buffer components, the nature of the alkyl group in the sulfite and the qualities of the electrical probes or electrodes. Modern embodiments of the Karl Fischer method are widely used and commercialised for control of quality standards set for foods and medicines.

The present invention takes advantage of improvements in the accuracy and availability of methods for determination of water vapour content in gases by spectroscopic methods. In particular the frequency modulated spectroscopy (FMS) of H₂O is accurate and sensitive and has led to use in the same quality control environments in pharmaceutical industry, for example for measurements of water content in the head spaces of closed vials with pharmaceutical ingredients (Andrews and Dallin; Frequency modulation spectroscopy in: SpectroscopyEurope; www.spectroscopyeurope.com). Classic spectroscopic methods with which water or other components were measured before in a gas flow, such as in JP59 174 739, are not selective enough for the quantitative and selectivity demands comparable to the Karl Fischer method. This type of spectroscopy has made highly accurate measurements of water concentration in the gas phase available, as is illustrated in U.S. Pat. No. 6,657,198. Sensitive spectroscopy is dependent on the generation of a sharp and intense light source of a particular wavelength, which is characteristic for water in gas phase. Such suitable wavelengths for water vapour can be found in the near infrared range (700 nm and 5000 nm). It is an object of the invention to provide for a highly selective measurement of water content in a sample. It is a further object of the invention to obliterate the need for chemicals as used in the Karl Fischer method, which chemicals are more costly and can be pollutants in our environment if not disposed of in a careful manner. It is a further object of the invention to shorten the analysis time for a water content determination and to improve on the convenience in the method needed for a water content determination. It should be realized that the method for determination of water content with the Karl Fischer method is a widely used method so that minor improvements have major impact on working costs.

The present invention provides for a method to determine the content of water in a sample by liberating the water from the sample followed by capturing the liberated water vapour in a gas flow and measuring cumulatively the water content in the gas flow by spectroscopy. The method according to the invention is economical in its simplicity and avoids the use of chemicals as common for the Karl Fischer reaction. Such chemicals will have, in turn, to meet high standards of purity and make the method less reliable in lesser equipped environments or staffed by lesser qualified people. The accuracy of the new method is more dependent on the instrument and less dependent on human actions in the analysis.

The term ‘sample’ as used in the context of this specification refers to a discrete and separate quantitative amount obtained for the purpose of analysis of the water content. It can be a weighed or otherwise measured amount from a larger amount of which the water content needs to be determined, or it can be a representative specimen of a larger number of specimens of which the water content needs to be determined. Such samples can be a weighed amount of a chemical or other composition or material which can contain water.

In one embodiment the water can be liberated from the sample by heating the sample to a sufficiently high temperature to force the release of water into the gas phase in contact with the sample. The heating temperature can be varied. Generally, lower temperatures are needed to liberate water molecules less tightly bound and higher temperatures to liberate water more tightly bound, such as water captured in hydrate crystals. Other embodiments may use the method by liberating water after chemical reactions which release water as reaction product. In all embodiments it is the purpose of the method to determine the liberated water quantitatively.

Once the water is liberated from the sample into the gas phase near the sample, the water is transported in a gas flow and led through a measurement area. The water vapour concentration in the measurement area is measured accurately either continuously or at discrete points in time. In order to be able to measure accurately and cumulatively the amount of water which passes in the measurement area, the gas flow through the measurement area should be constant and/or under control. In preferred embodiments the gas flow is metered and can be controlled carefully. The gas flow or flux through the measurement area is a key parameter for the determination of the amount of gas that flowed through the measurement area. Likewise, all dimensions of the measurement area are to be controlled for quantitative determination of the cumulative gas vapour flux. An oblong measurement area, such as a tube, is preferred. Turbulent effects on the gas flow by the shape of the measurement area should be avoided. In one preferred embodiment, the measurement area can be a tube of known diameter, which is transparent for the light source of the spectrometer and in which the gas flows with known and controlled velocity. High transparency of the tube material for near-infrared light is most preferred. Various suitable calibration techniques for the water content determination in a sample are available to the skilled person for quantification, see for example WO03/019176. It should not be ignored that certain types of samples may not be suitable in view of contaminants in the gas phase with absorption of light in the same infrared frequency as water vapour. It is common practice in the field to validate methods when these are to be used for routine control of samples of the same characteristics.

With a spectrometer or photodetector in the critical spectral area the water concentration in the gas flow is measured continuously or as intermittent time points over a period of time. The total content of water vapour leaving the sample is determined by measuring the water content in the gas flow cumulatively by integration over time of the measurements.

In principle every spectroscopic method that determines specifically the water vapour concentration in a gas flow can be used. At present the lowest detection limit and highest speed can be obtained with wave length modulated or frequency modulated (FMS) spectroscopy (Allen, 1998, Wilson et al., 1995). Water vapour (moisture) absorbs near-infrared light in a band of transitions around 1.382 μm. This water vapour 101 band is a series of ro-vibrational transitions that combine the symmetric stretch (μ₁ 3657 cm⁻¹, 2.734 μm) and asymmetric stretch (μ₃ 3756 cm⁻¹, 2.662 μm). This absorption in this small band can be measured with light emitted by frequency modulated diode emitters, such as tunable InGaAsP diode lasers, which operate near 1390 nm (Arroyo and Hanson, 1993). Other peaks, such as the 1880 nm absorption line of water, may also be used in the near-infrared region provided that a sharp, specific and powerful laser light beam can be generated at the wavelength of the absorption peak. Instruments are available based on this technique, with which head space water vapour can be determined (Lighthouse Instruments). It is the emergence of the extremely accurate techniques to manufacture such sharp and specific light emitters, that have enabled the new use according to this invention. The new use is in particular providing for a strong need in environments of routine control of water content in samples with a standardized method. Such environments exists in many production centres whereby water content of the products within narrow quality demands need to be checked.

### REFERENCES

Allen, M. G. Diode laser absorption sensors for gas-dynamic and combustion flows. Meas. Sci. Technol. Vol 9, pp 545-562, 1998
Arroyo, M. P. and Hanson, R. K. Absorption measurements of water-vapor concentration, temperature, and line-shape parameters using a tunable InGaAsP diode laser. Applied Optic Vol 32, pp 6104-6116. 1993
Wilson et al., A low-cost, high-speed, near-infrared hygrometer. Rev. Instrum., Vol 66, pp 5618-5624, 1995
Andrews and Dallin. Frequency modulation spectroscopy. SpectroscopyEurope, www.spectroscopyeurope.com, pp 24-26

### LEGENDS TO THE FIGURES

FIG. 1: Schematic diagram of the open ended passage vial; 1=Inlet into vial; 2=Outlet from vial

FIG. 2: Signal of light absorption by H₂O over time as recorded by FMS spectroscopy in the gas flow leaving a heated sample of 5.73 mg Na-tartrate.

FIG. 3: Signal of light absorption by H₂O as recorded by FMS spectroscopy in the gas flow leaving a heated sample of 14.44 mg Na-tartrate.

FIG. 4: Signal of light absorption by H₂O as recorded by FMS spectroscopy in the gas flow leaving a heated sample of 31.94 mg Na-tartrate.

FIG. 5: Signal of light absorption by H₂O as recorded by FMS spectroscopy in the gas flow leaving a heated sample of 44.88 mg Na-tartrate.

FIG. 6: Correlation between Area under the curve of light absorption by water in the gas flow as determined by FMS spectroscopy (=Area (x)) and total water content in the Na-tartrate.2H₂O standards (Area(x)=211.87x+1479.2; x=sample weight; r²=0.9956).

### EXAMPLE

The cumulative measurement of amount of water in a sample is illustrated by the use of an FMS-1400 HEADSPACE PRESSURE/MOISTURE ANALYZER provided by Lighthouse Instruments Inc. This is a non-destructive gas analyzer for simultaneously monitoring moisture partial pressure and total headspace pressure in sealed parenteral containers. This analyzer utilizes a laser absorption technique. The amount of laser light absorbed is proportional to the water vapor concentration. It was recommended for applications such as leak detection, direct measurement of water activity, container closure integrity studies, stability trends and moisture permeability studies.

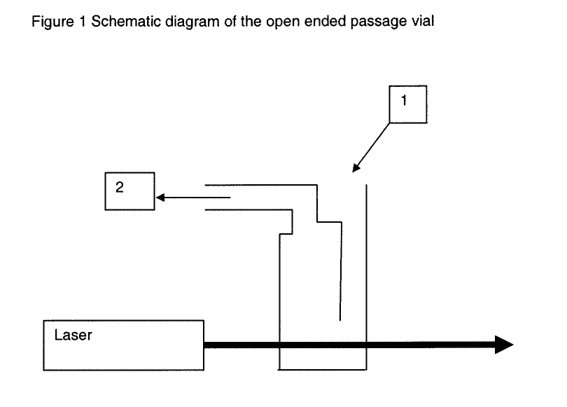

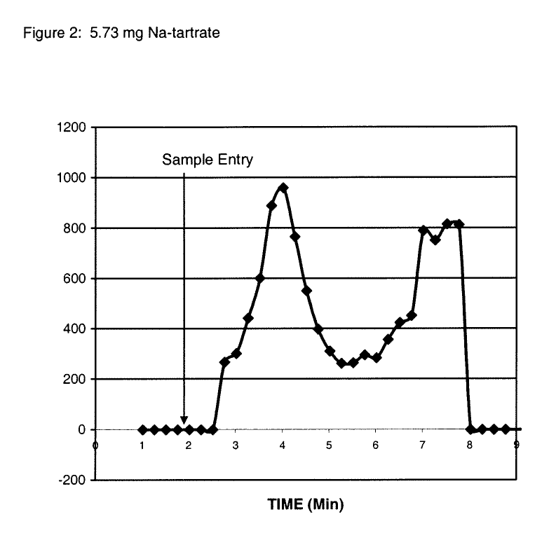

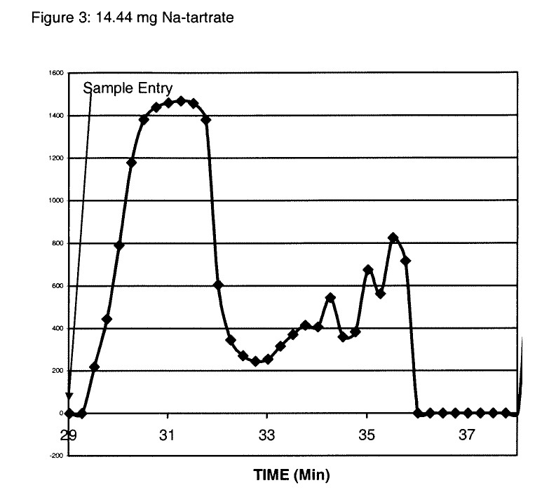

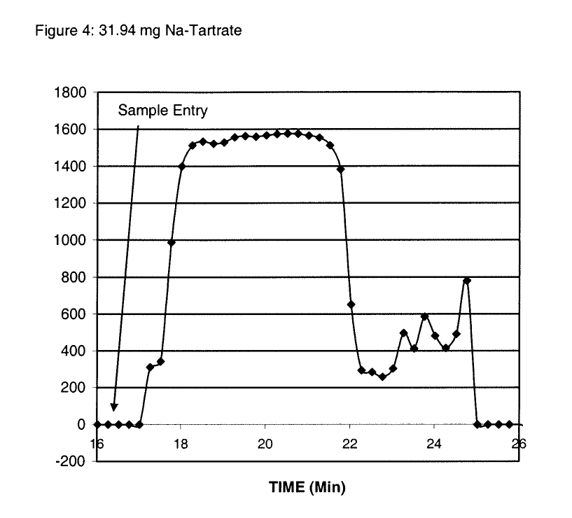

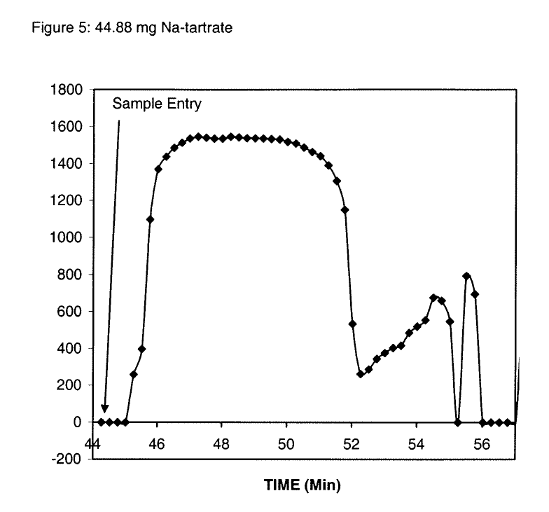

A sample of sodium tartrate containing 2 moles of crystal water per mole tartrate is placed in an oven, such as one which is usually used in the combinations for Karl Fischer water determination. Water vapour leaving the sample when heated at 170° C., is transported in a nitrogen gas flow to a vial placed in the FMS instrument. This instrument is not yet specifically designed for the present purpose since it is constructed to measure water vapour in a closed vial, however, for the present purpose the vial is open ended for passage of the nitrogen flow as in FIG. 1. The water vapour content in the nitrogen gas flow was measured each 15 seconds. Differing amounts of a sodium tartrate water standard were weighed and placed in the oven. In FIGS. 2 to 5 results are shown.

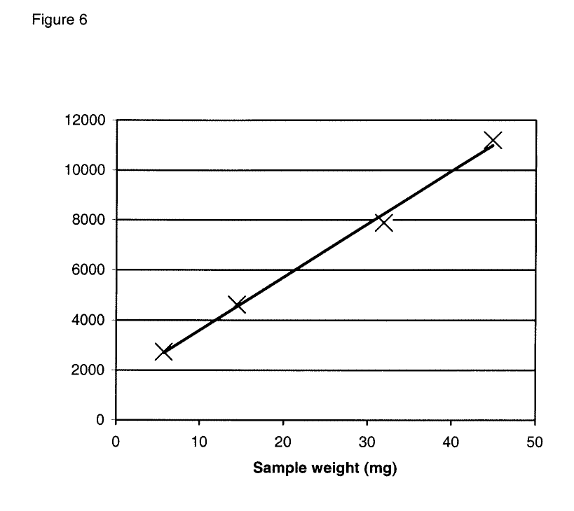

The areas under the curves were calculated and used for the construction of the calibration curve of FIG. 6.

### CONCLUSION

The results shows a very good correlation between area under the curve and the amount of water standard (FIG. 6). The method as exemplified can be further optimized by improvements of the instrument/vial combination. The vial as measurement area needs to be small and designed to avoid turbulence. The vial is not yet optimally kept at a constant and most suitable temperature. The nitrogen flow and gas temperature can be better controlled than is presently done, since the exemplified method used an oven from a Karl Fischer set-up. The sampling rate with which the water vapour content in the gas was monitored was each 15 seconds, which can be improved by automation of the method.

1. A method to determine the content of water in a sample by liberating the water from the sample followed by capturing the liberated water in a gas flow and measuring cumulatively the water vapour content in the gas flow by wave length modulated or frequency modulated spectroscopy (FMS) in the near infra-red light absorption region.

2. The method according to claim 1, characterised in that the spectroscopy is by measuring absorption by water vapour in a band of transitions around 1.382 μm.
